(19) United States
(12) Patent Application Publication
(10) Pub. No.: US 2017/0251611 A1
(43) Pub. Date: Sep. 7, 2017

(54) Potted Plant Netting System

(71) Applicant: Kathleen Ewers, San Antonio, TX (US)

(72) Inventor: Kathleen Ewers, San Antonio, TX (US)

(21) Appl. No.: 15/355,926

(22) Filed: Nov. 18, 2016

Related U.S. Application Data
(60) Provisional application No. 62/301,725, filed on Mar. 1, 2016.

(51) Int. Cl. A01G 13/10; A01G 9/04; A44B 18/00; A01G 9/02

(52) U.S. Cl. CPC A01G 13/10; A01G 9/02; A01G 9/04; A44B 18/0069; A01G 2013/006

(57) ABSTRACT

The container netting system is comprised of a pot, saucer, and a net. The net is positioned around the pot and saucer to restrict the access to the interior of the saucer. The mesh openings of the net are sized to prevent a mosquito, or other bug, from accessing the water to lay eggs.

### CROSS-REFERENCES TO RELATED APPLICATIONS

This application claims the benefit of U.S. Provisional Application Ser. No. 62/301,725 filed Mar. 1, 2016. The contents of that application are incorporated by reference herein.

### STATEMENT REGARDING FEDERALLY SPONSORED RESEARCH OR DEVELOPMENT

Not applicable.

### BACKGROUND OF THE INVENTION

1. Field of the Invention

The present invention relates to a net used in conjunction with a pot and saucer to restrict access to the water.

2. Background of the Related Art

The invention relates to a potted plant netting system to prevent insects and animals from accessing standing water that may be present in a saucer. When watering a potted plant, excess water drains through the pot, out drainage ports, and into a saucer. In certain settings it is preferred to use a saucer to catch the excess water as opposed to allowing the excess water to drain uncontrolled. For example, indoor potted plants routinely have saucers as do potted plants in courtyards or concrete patios. However, the presence of the standing water within a saucer is problematic. Household animals such as dogs and cats may attempt to drink the water resulting in exposure to unwanted chemicals, such as fertilizer, or may inadvertently knock over the pot. More problematic is the potential for mosquitoes and other nuisance insects to lay eggs in the standing water which perpetuates the insects life cycle in an unwanted area such as indoors or within a courtyard area. The standing water in a saucer is an ideal habitat for mosquito larva and pupa as the organic material within the dirt of the potted plant provide a source of nutrition.

The present solution to this problem is to physically empty the saucer by moving the pot and dumping the saucer. This has obvious drawbacks as it is labor intensive and impractical for heavy pots. A need exists to easily prevent access to the standing water without the necessity of physical movement of the pot and saucer.

### SUMMARY OF THE INVENTION

The potted plant netting system is necessary to help reduce the access to standing water within a saucer. The potted plant netting system consists of a net affixed to a pot where it drapes below the lip of the saucer. This creates a cavity within the saucer defined by the saucer, the pot, and a net. The net prevents mosquitoes, other insects, or animals from accessing the water through use of a physical barrier. The net remains breathable such that the standing liquid may evaporate. The net may be affixed to the plant through hook and loop fasteners or through elasticity of the net.

The net has a positive effect on reduction of mosquitoes. First, it reduces the mosquito population in the localized area as it disrupts the life cycle by preventing the laying of eggs. Second, it reduces the existing population of the biting female mosquitoes as the female mosquitoes will search for sources of standing water to lay eggs. In a courtyard, backyard patio, or indoors, this will result in less biting mosquitoes and less risk to exposure to mosquito borne illnesses such as West Nile virus or Zika. The use of netting will also physically prevent an animal, such as a dog or cat, from easy access to the water.

### BRIEF SUMMARY OF THE DRAWINGS

FIG. 1 is a side view of the planter system.

FIG. 2 is a view of the exterior face of the netting.

FIG. 3 is a view of the interior face of the netting.

FIG. 4 is a close-up view of the exterior face of the netting.

FIG. 5 is a side view of the pot with saucer.

FIG. 6 is a close up view of the planter system without the mess pattern.

### DETAILED DESCRIPTION

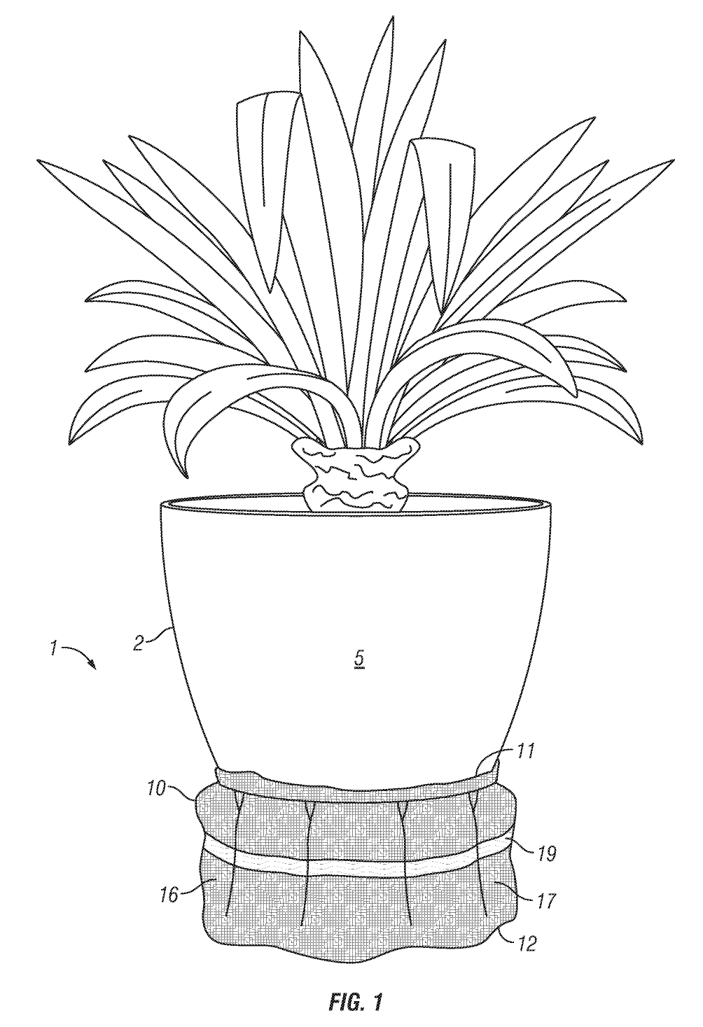

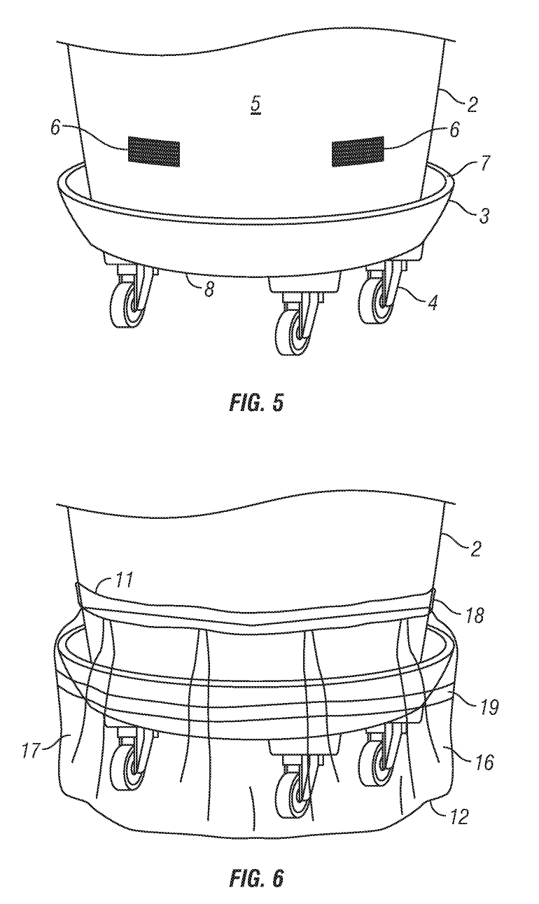

FIGS. 1 and 6 show the present planter system invention 1 comprising a pot 2, a saucer 3, and net 10. The pot 2 is generally round may be any shape such as square, rectangular, or oval. The pot 2 has drainage ports to allow excess water from the pot 2 to drain out. A saucer 3 is positioned underneath the pot 2 to catch the excess water flowing out of the drainage ports. As seen in FIGS. 5 and 6, the saucer 3 is positioned directly under the pot 2 where the pot 2 sits on top of the saucer 3. In some planters, wheels 4 are mounted under the saucer 3 to allow the planter system 1 to move. Attached to the exterior surface 5 of the pot 2 are several securing loops 6 of hook and loop fasteners.

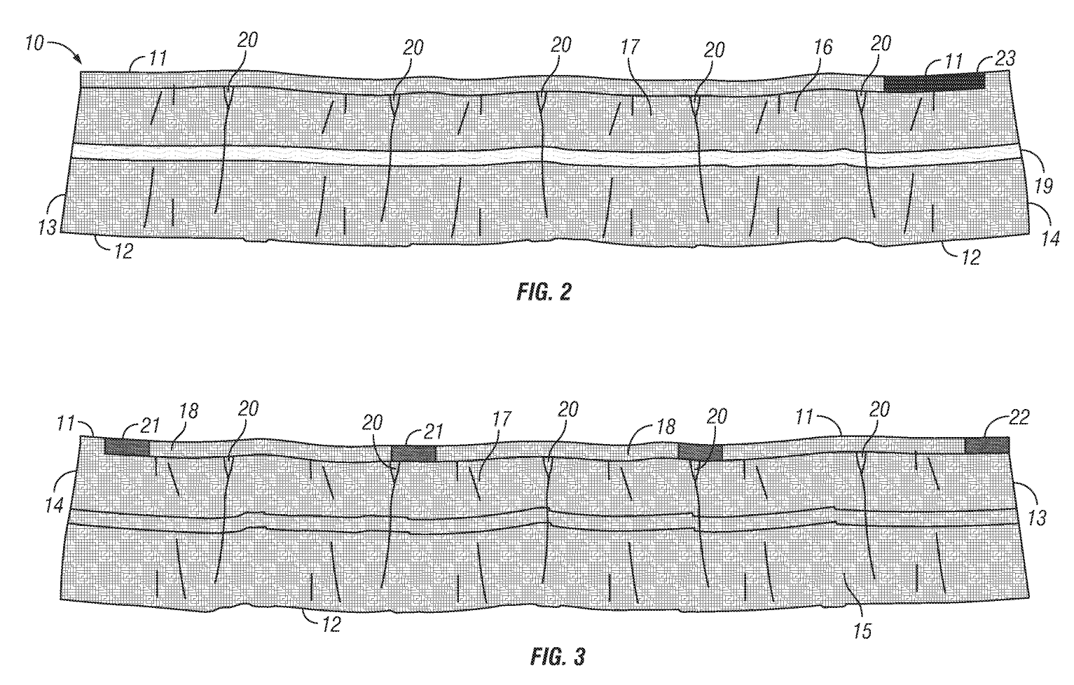

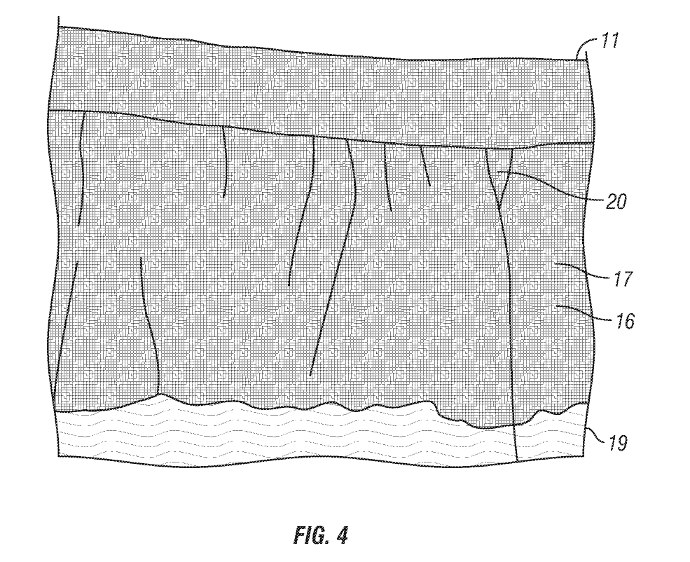

As seen in FIGS. 2, 3, and 4, the net 10 is generally rectangular in shape having a top portion 11, bottom portion 12, left portion 13, right portion 14, an inner face 15, and an outer face 16. The net 10 consists of a mesh pattern 17 having openings within the netting are of sufficient size to allow air to flow through but sufficiently small to prevent a mosquito or other targeted insect from passing through. The mesh pattern 17 is made through use of lockstitch which keeps the bottom portion 12 from fraying. In other embodiments the mesh pattern 17 may be smaller to block any desired insect such as flies, gnats, or fruit flies. The mesh pattern 17 may be square, diamond, or any other suitable shape. A strip of material 18 is positioned on the net adjacent and parallel to the top portion 11. A decorative strip of material 19 is positioned on the net approximately equidistant between the top portion 11 and bottom portion 12 and parallel to both top and bottom portions 11, 12.

The top portion 11 of the net 10 is affixed to a strip of material 18. In one embodiment the strip of material 18 is elastic. The top portion 11 of the net 10 is folded into small wedges 19 that taper towards the bottom portion 12. These wedges 20 are commonly referred to as darts in sewing. The top portion 11, with the wedges 20, are attached or sewn to the strip of material 18 while the strip of material 18 is taut. The strip of material 18 is positioned on the inner face 15 of the net 10. After the top portion 11 is attached and the strip of material is not taut, the top portion 11 of the net pulls together causing the net to appear trapezoid in shape as the left and right sides become angled. The wedges 20, when the strip of material 18 is not taut, help prevent folds in the material when placed around a round object.

Several securing hooks 21, of hook and loop fastener, are affixed to the strip of material 18 along the top portion 11. A connection hook 22 is affixed to the strip of material 18 along the top portion 11 proximal to the left portion 13. A connection loop 23 is affixed to the top portion 11 of the outer face 16 proximal to the right portion 14.

The top portion 11 of the net 10 is wrapped around the exterior surface 5 of the pot 2. The securing hooks 21 on the net 10 connect to the securing loop 6 on the exterior surface 5 of the pot 2. The connection hook 22 connects with the connecting loop 23. The hook and loop fasteners secure the net 10 around the pot 2 which adjoins the left portion 13 and right portion 14. The elasticity of the strip of material 18 permit the top portion 11 of the net 10 to stretch around the pot 2. The wedges 20 prevent the material from bunching up around the bottom of the pot 2 and saucer 3.

As seen in FIG. 6 (the mesh pattern 17 is removed for easier view), the net 10 drapes down such that the bottom portion 12 rests below the lip 7 of the saucer 3. The net 10 may be positioned such that the bottom portion 12 extends beyond the bottom of the saucer 8 to make the bottom portion 12 flush with the ground. The bottom portion 12 may be trimmed or cut depending on the height of the pot 2 and saucer 3. The lockstitch of the mesh pattern 17 permits the net 10 to be trimmed without fraying. A cavity is formed between the saucer 3, the external surface 5 of the pot 2 and the net 10. The net 10 acts as a barrier between the cavity, and the interior 9 of the saucer 3, and the surrounding environment. To the extent any standing water or liquid exists in the saucer 3, the net prevents a desired animal or insect from accessing the liquid. In one embodiment the mesh pattern 17 of the net 10 is square having dimensions of 1.2 by 1.2 millimeters which is effective to block a mosquito from flying through the net 10. The 1.2×1.2 millimeter standard is established by the World Health Organization guidelines for malaria prevention. One of ordinary skill in the art would understand the size of the mesh pattern may be changed depending on the size of the insect to be blocked. Furthermore, the net may also be used to prevent an animal, such as a dog or cat from accessing any of the standing water. The mesh openings permit air flow which allows the standing water to evaporate depending on atmospheric conditions.

In another embodiment hook and loop fasteners are attached directly to the inner face of the net, along the top portion. In this embodiment the strip of material is not necessary.

In another embodiment, the elasticity of the strip of material, along with the use of fastener to adjoin the right and left portions, is sufficient to attach the net to the pot. In this embodiment, the friction of the elastic strip of material against the exterior surface of the pot is sufficient to keep the net in place.

In another embodiment the netting is shaped as a sack. The bottom portion of the sack encompasses the saucer and extends up onto the exterior of the pot. The sack is attached or fastened to the pot using hook and loop fasteners, elastic strip of material, or both.

The present disclosure is described above in terms of a preferred illustrative embodiment of a planter system. Those skilled in the art will recognize that alternative constructions of such an apparatus can be used in carrying out the present invention. Other aspects, features, and advantages of the present invention may be obtained from a study of this disclosure and the drawings, along with the appended claims.

I claim:

1. A container netting system comprising
a pot having drainage ports positioned near the bottom of said pot;
a saucer positioned to collect drainage from said drainage ports;
a net having mesh openings; and
a cavity defined by said saucer, the exterior surface of said pot, and said net wherein said drainage ports open into said cavity.

2. A container netting system of claim 1 wherein each said mesh opening is approximately 1.44 millimeters squared.

3. A container netting system of claim 1 wherein said net has at least 120 said mesh openings per square inch.

4. A container netting system of claim 1 wherein the top portion of said net is positioned around the exterior surface of said pot.

5. A container netting system of claim 4 wherein the bottom portion of said net is positioned around the exterior surface of said saucer.

6. A container netting system of claim 4 wherein the top portion is attached to said pot through hook and loop fasteners.

7. A container netting system of claim 4 wherein an elastic strip of material is attached to the inner face of said top portion of said net.

8. A container netting system of claim 7 wherein said net has at least one dart positioned near said top portion.

9. A container netting system of claim 1 wherein said net is stitched using a lockstitch.

10. A potted plant net comprising
a net having a top portion, bottom portion, right portion, left portion, and mesh openings;
an elastic strip of material attached to the inner face of said top portion; and
a fastener for linking said right portion with said left portion.

11. A potted plant net of claim 10 wherein said net has at least one dart positioned near said top portion.

12. A potted plant net of claim 10 wherein said net is stitched using a lockstitch.

13. A potted plant net of claim 10 wherein said fastener is a hook and loop fastener.

14. A potted plant net of claim 10 wherein each said mesh opening is approximately 1.44 millimeters squared.

15. A potted plant net of claim 10 wherein said net has at least 120 said mesh openings per square inch.

16. A potted plant net of claim 10 further comprising fasteners positioned on the inner face of said top portion of said net.

17. A potted plant net of claim 16 wherein said fastener is a hook and loop fastener.
